(19) United States
(12) Patent Application Publication
(10) Pub. No.: US 2009/0084274 A1
(43) Pub. Date: Apr. 2, 2009

(54) Kitchen appliance comprising a safety system and method for operating a kitchen appliance

(75) Inventors: Peter Kovacic, Gomilsko (SI); Marjan Mak, Gomilsko (SI); Jurij Pesec, Petrovce (SI); Darko Rudez, Sentjur (SI)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 11/991,053

(22) PCT Filed: Aug. 16, 2006
(86) PCT No.: PCT/EP2006/065356

§ 371 Date: Feb. 25, 2008

(30) Foreign Application Priority Data
Aug. 26, 2005 (DE) 10 2005 040 525.8

(51) Int. Cl. A47J 43/07; A47J 43/04; A47J 43/00

(52) U.S. Cl. 99/492; 99/337; 99/348

(57) ABSTRACT

A kitchen appliance includes a circuit closer and, a safety lock system which unlocks the circuit closer and permits operation of the kitchen appliance only if the kitchen appliance is properly assembled. The safety lock system includes switches having sensors.

The present invention relates to a kitchen appliance, in particular an electromotive kitchen appliance, preferably an electromotive single-purpose or universal food processor, comprising a circuit closer and a safety lock system assigned to the circuit closer, which unlocks the circuit closer and permits operation of the kitchen appliance only if the kitchen appliance is properly assembled. It also relates to a method for operating a kitchen appliance.

DE 691 01 451 C1 relates to an electrical kitchen appliance with a number of functions for processing food and having a housing. A region of the housing forms a base that can hold various accessories, which have a working bowl with a cover, in which a tool rotates. The tool can be a mincer, a vegetable slicer or a juicer for example and it is driven through an opening configured in the base of the bowl by the output shaft of a motor. The appliance has an electrical control device for switching on the motor, said device having a detector device to determine the presence of the cover on the working bowl, which can switch the control device to an active position, in which the motor can be switched on, if the cover is in its correct closed position on the working bowl. The control device also has a speed regulator, which is intended to adjust the rotational speed of the drive shaft depending on the tool used. The detector device has a Hall sensor to determine the presence of a working bowl or a cover, said Hall sensor being able to detect the magnetic field of a magnet.

DE 31 21 252 discloses a multipurpose domestic appliance with a number of interchangeable food preparation tools and a removable dish, which comprises a magnetically active safety block system, which can be used to monitor the proper positioning of the dish in the domestic appliance. Errors by the magnetic block system are prevented in that alternating magnetic fluxes are used.

The object of the present invention is to provide a kitchen appliance, in particular an electromotive kitchen appliance and a method for operating a kitchen appliance, with which a high level of safety is ensured with simple means during operation of the kitchen appliance. According to the invention this object is achieved by a kitchen appliance and a method for operating a kitchen appliance as set out in the independent claims. Further advantageous refinements and developments, which can be used individually or can be combined with each other in any manner, are set out in the respective dependent claims.

The inventive kitchen appliance, in particular electromotive kitchen appliance, preferably electromotive single-purpose or universal food processor, comprises a circuit closer and a safety lock system assigned to the circuit closer, which unlocks the circuit closer and permits operation of the kitchen appliance only if the kitchen appliance is properly assembled and is characterized in that the safety lock system has at least four, preferably six, separate magnetic switches with magnetic sensors.

A pureeing, mixing, chopping, kneading and/or cutting tool, whisk or beater, drinks blender, slicer, grinder, citrus or fruit press and/or meat mincer can be inserted as tools in the kitchen appliance. The kitchen appliance has a number of holders in particular for the different tools.

The safety lock system ensures that the kitchen appliance can only be operated if it is ensured with the aid of the magnetic switch that the appliance is properly assembled or that a tool is connected properly to the kitchen appliance. Only if all the magnetic switches respectively output a signal, which corresponds to the “properly assembled” state, can the safety lock system unlock the circuit closer. Logically this corresponds to an AND linking of the switches and it can be implemented by means of a series circuit for connection purposes. The safety lock system has magnetic sensors, which detect a proper connection or proper assembly of the kitchen appliance. The magnetic sensors are in particular Reed sensors.

Hall sensors can also be used as the magnetic sensors in a modification of the invention.

The magnetic switches can in particular operate separately in such a manner that they switch independently of each other both spatially and electrically. The sensors can be arranged separately from each other for example spatially and/or for connection purposes and can act separately. The sensors are used to monitor the proper assembly of the kitchen appliance or the proper connection of the kitchen appliance to a tool. If one of the plurality of magnetic switches outputs a signal to the safety lock system that the kitchen appliance is not properly assembled, the circuit closer of the kitchen appliance is not unlocked and the kitchen appliance cannot be operated. The blocking of the circuit closer as effected by the safety lock system means that a high level of safety can be achieved during operation of the kitchen appliance, in that the magnetic switches or magnetic sensors are positioned spatially or functionally on the kitchen appliance at points where a risk of danger originates.

The inventive kitchen appliance can comprise at least one magnetic switch with at least one magnetic sensor, which is a Reed sensor. Reed sensors are magnetic-action sensors, in which an electric switch is actuated by the presence or absence of a magnet, as soon as the magnet is moved out of the spatial region covered by the sensor or is moved into the spatial region covered by the sensor. Reed contacts have comparatively small dimensions and allow a contactless mode of operation, are economical and operate with a high level of reliability. Reed sensors for example close an electrical contact, as soon as a magnetic field strength in their sensor region exceeds a specified value. This means that incorrect operation of the magnetic switch can be almost excluded. To this end the Reed sensor is in particular arranged so that the unwanted influence of external magnetic field, for example of the magnets in domestic use (for example magnets on a magnetic pin board), is avoided. For example a magnetic is arranged in a recess on the housing of the kitchen appliance, into which the magnet of the magnetic switch can pass but standard magnets in domestic use cannot fit, so that they always remain at a sufficient distance from the magnetic sensor.

A Reed sensor or Reed switch generally consists of two contact tongues made of a ferromagnetic material, which have been sealed hermetically into a glass tube in an inert atmosphere (e.g. nitrogen or rare gases). After sealing, the contact tongues overlap within the glass body and form a gas gap in the contact region. Both tongues can be coated in the contact material in the contact zone (e.g. rhodium, ruthenium, etc.). With the approach of a sufficiently strong magnetic field, both contact tongues assume a counter magnetic polarity, thereby closing the contact. The advantages of Reed sensors are that it is possible to switch in a contactless manner, they are economical to produce, do not require a power supply and (apart from exceptions, such as tungsten contacts) do not require a minimum current. They generally ensure a very reliable contact, have a low transfer resistance (0.07 to 0.2 ohms when new) and a long useful life of many hundreds of millions to more than a billion switching operations at signal load. Since they are hermetically sealed, they can also be used without hesitation in a domestic situation and also with food. A basic distinction is made between closing contacts (SPST-NO for Single Pole Single Throw—Normally Open), opener contacts (SPCT-NC, i.e. Single Pole Single Throw—Normally Closed), switching contacts (SPDT—Single Pole Double Throw) and distable contacts.

The kitchen appliance in particular has at least one attachable blender receptacle, which can be connected to the kitchen appliance with a first tool coupling, with a first magnetic sensor for monitoring proper connection of the blender receptacle to the kitchen appliance being provided on the first tool coupling. The blender receptacle can be configured as a blender bowl. It is fixed to the kitchen appliance with the first tool coupling, with a tool that can be attached to the kitchen appliance preferably being inserted into the blender receptacle. It is ensured with the aid of the first magnetic sensor that the attachable blender receptacle is connected properly to the kitchen appliance.

In a further advantageous refinement the blender receptacle has a receptacle cover and a second magnetic sensor is provided to monitor the proper closing of the blender receptacle with the receptacle cover. It is thus detected with the aid of the second magnetic sensor whether the blender receptacle is properly closed with the receptacle cover. This can be particularly advantageous, if a tool is fixed to the kitchen appliance, which operates in the blender receptacle, e.g. a cutter, and there is a potential risk from the tool in operation, if the blender receptacle is not completely and properly closed with the receptacle cover.

The second magnetic sensor is advantageously arranged on the first tool coupling, preferably on the kitchen appliance, with a rod that can be moved to and fro between a first position and a second position, in particular a coupling bar, being provided in particular on the blender receptacle, in particular in a receptacle handle provided on the blender receptacle, said rod engaging with the receptacle cover in such a manner that the rod assumes the first position when the receptacle cover is properly closed and otherwise the second position, with the second magnetic sensor being able to be actuated with the aid of the rod. It is thus possible to actuate the second magnetic sensor, which can be spatially removed from the blender receptacle, with the aid of the rod. This is particularly advantageous, if a magnetic sensor cannot or should not be fixed to the blender receptacle itself, since electrical contact between the magnetic sensor and the kitchen appliance is difficult, complex or susceptible to interference. The rod is used to forward the information about whether the blender receptacle is properly closed or not mechanically to the first tool coupling, on which the second magnetic sensor is fixed on the kitchen appliance side.

In a further advantageous refinement the kitchen appliance has at least one attachable first tool, in particular a pureeing, mixing, chopping, kneading and/or cutting tool, whisk or beater, drinks blender, slicer, grinder, citrus or fruit press and/or meat mincer, it being possible to connect the tool to the kitchen appliance with a second tool coupling, with a third magnetic sensor for monitoring the proper connection of the first tool to the kitchen appliance being provided on the second tool coupling. The kitchen appliance in particular has a number of tool couplings, in order to be able to hold the respective tools in a corresponding position. For example a pureeing tool is held from the top by the kitchen appliance, while a drinks blender is placed on the kitchen appliance and held from below. A grinder or meat mincer can be held at the side, with correspondingly slow rotation speeds having to be present here. The respective tools can be held securely with the aid of the corresponding tool couplings. A corresponding magnetic sensor, in other words a third magnetic sensor for the second tool coupling, is used to monitor the proper connection of the tool to the kitchen appliance.

In a further refinement of the invention the kitchen appliance has at least one attachable second tool, in particular a pureeing, mixing, chopping, kneading and/or cutting tool, whisk or beater, drinks blender, slicer, grinder, citrus or fruit press and/or meat mincer, which can be connected to the kitchen appliance with a third tool coupling, with a fourth magnetic sensor for monitoring the proper connection of the second tool to the kitchen appliance being provided on the third tool coupling.

The plurality of tools that can be inserted and attached means that the kitchen appliance can be deployed and utilized in many ways. The magnetic sensors are used to monitor a proper connection between the respective tool and the kitchen appliance. However the magnetic sensors can also be used to determine which tool, in particular which tool type, is inserted into or attached to the kitchen appliance. By identifying which tool is connected to the kitchen appliance, the kitchen appliance, in particular an electric motor in the kitchen appliance, can be activated accordingly. It is then possible to predetermine a corresponding speed level or power stage of the electric motor, depending on the type of tool used.

The kitchen appliance advantageously has a number of, in particular at least three, tool couplings for different tools, in particular pureeing, mixing, chopping, kneading and/or cutting tools, blender receptacles and/or meat mincers, with at least one magnetic sensor being assigned in particular to each tool coupling. In one specific refinement of the invention at least one magnetic sensor, in particular at least two, advantageously a majority of the magnetic sensors can identify the type of tool inserted. The kitchen appliance in particular comprises an appliance controller, which influences the mode of operation of the kitchen appliance, in particular the speed level and/or power stage of an electric motor, according to the identification. For example a comparatively slow speed has to be selected for a meat mincer or grinder, while higher speeds are advantageous for a beater.

The kitchen appliance in particular has an appliance housing and an appliance housing cover and a fifth magnetic sensor is provided to monitor the proper closing of the appliance housing with the appliance housing cover. The magnetic sensor is therefore used to determine whether the appliance housing cover is positioned correctly on the appliance housing.

The magnetic switches and magnetic sensors are advantageously provided and/or arranged in such a manner that a magnetic switch is actuated only if an interface to be monitored by said magnetic switches is fully functional and fuse-protected. For example the safety lock system can be cleared or released only if the tool is completely removed from the tool holder or only if the tool is fully inserted in the kitchen appliance. The lock system is set for example so that the circuit closer of the kitchen appliance can be actuated only if it is essentially fully ensured that there is no longer any risk of injury to the user of the kitchen appliance.

In a particularly advantageous refinement of the invention the magnetic switch has a recess, in which the magnetic sensor is arranged and in which a magnet of the magnetic switch can engage, to reduce interference due to external magnets. This means that external magnets, many of which are used in the domestic situation (e.g. magnets on a magnetic pin board) cannot influence the magnetic switch, as they do not fit into the recess and are therefore kept at a distance from the magnetic sensor. The recess ensures that external magnets are far enough away from the magnetic sensor that the magnetic field generated by the external magnets is sufficiently small at the site of the magnetic sensor and cannot cause the unlocking of the circuit closer. This further enhances the reliability and safety of the kitchen appliance.

The inventive method for operating a kitchen appliance, in particular an electromotive kitchen appliance, preferably a single-purpose or universal food processor, particularly preferably an inventive kitchen appliance, with the kitchen appliance having a number of insertable tools, in particular a blender receptacle, pureeing, mixing, chopping, kneading and/or cutting tools, whisks or beaters, drinks blenders, slicers, grinders, citrus or fruit presses and/or meat mincers, one of the tools being held by the kitchen appliance, provides that at least one sensor, in particular a magnetic sensor, is used to identify the tool type of the tool inserted and the mode of operation of the kitchen appliance, in particular the speed level and/or power stage of an electric motor, is influenced, in particular adjusted, according to the identification. The magnetic sensor here can be a Reed sensor.

This method can be used to identify a tool safely and reliably and to ensure that operation takes place at the correct power stage and speed level. The use of Reed sensors is particularly advantageous here. Reed sensors have proven to be particularly robust and are comparatively unsusceptible to interference in respect of the small magnets generally present in a domestic situation.

Further advantageous details and refinements, which can be used respectively or combined in any manner with each other, are described in more detail with reference to the following drawings, which do not restrict the invention but are intended to illustrate by way of example and in which:

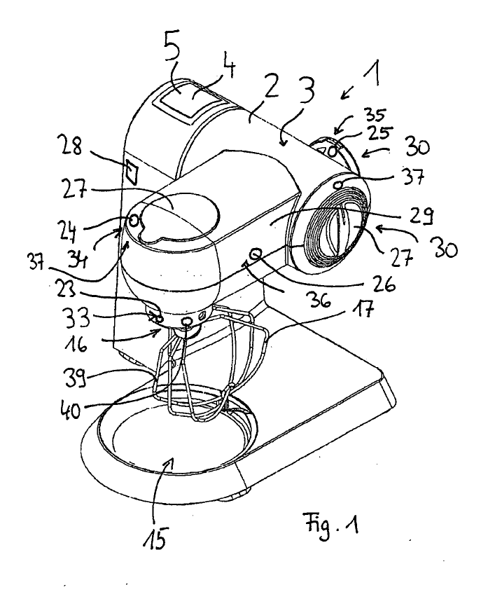

FIG. 1 shows a perspective oblique view of an inventive kitchen appliance from the side and top,

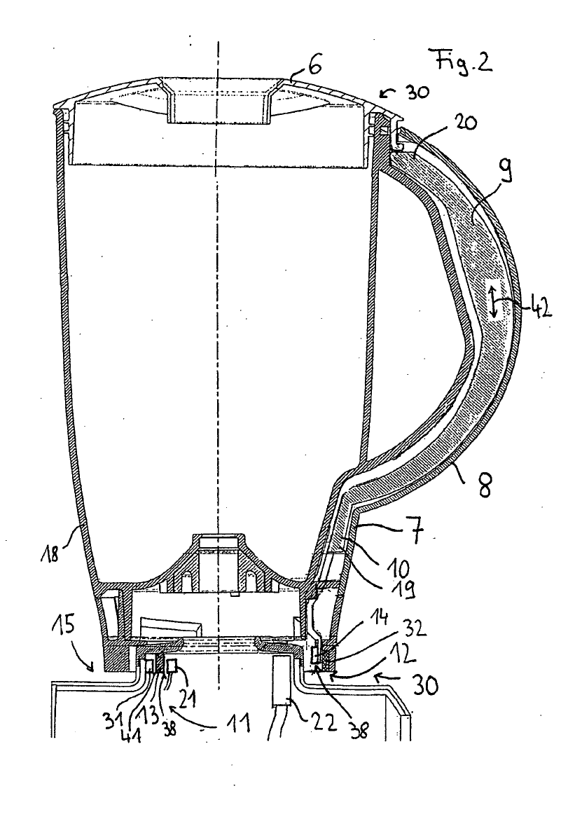

FIG. 2 shows a longitudinal section of a blender receptacle of the inventive kitchen appliance inserted in an inventive kitchen appliance with the receptacle cover inserted; and

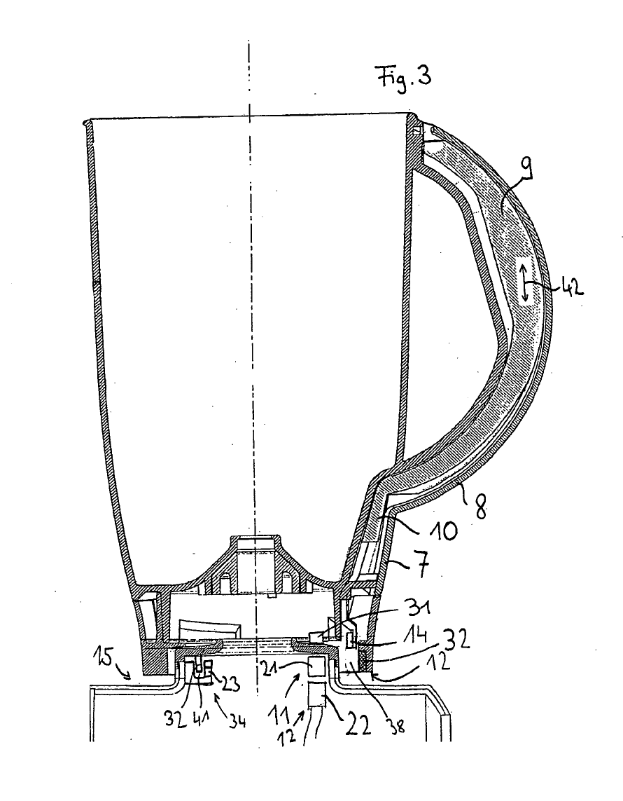

FIG. 3 shows a longitudinal section of a blender receptacle inserted in an inventive kitchen appliance with the receptacle cover not inserted.

FIG. 1 shows an inventive kitchen appliance 1 with an appliance housing 2, which has an electric motor 3, which can be activated using a circuit closer 4. The circuit closer 4 is active or can be activated only if it is released by a safety lock system 5. The safety lock system 5 ensures that a first tool 17 configured for example as a beater 39 and a second tool 18 configured for example as a blender receptacle 7 (see FIGS. 2 and 3) are inserted properly into the kitchen appliance 1. The safety lock system 5 also ensures that a receptacle cover 6 for the blender receptacle 7 (see FIGS. 2 and 3) is properly closed. Once the safety lock system 5 has identified that the kitchen appliance 1 has been fully assembled or that the tools 17, 18 have been properly connected, the circuit closer 4 is activated so that the electric motor 3 or kitchen appliance 1 cannot be operated before this point. This significantly enhances safety when using the kitchen appliance 1. The kitchen appliance 1 has a first 15, second 16 and third 27 tool coupling, which are monitored by corresponding magnetic sensors 21-26 (see also FIGS. 2 and 3). For example the second tool coupling 16 is monitored with the aid of a third magnetic switch 33, which has a third magnetic sensor 23. A third tool coupling 27 is monitored with the aid of a sensor 37, which can be configured as a fourth magnetic sensor 24. The fourth magnetic sensor 24 is assigned to a fourth magnetic switch 34, which is used to monitor complete closing of the third tool coupling 27. The magnetic switches 11, 12, 33-36 and the magnetic sensors 21-26 are provided or arranged on the respective tool couplings 17, 18, 27 in such a manner that they can be actuated only if an interface 30 to be monitored by said magnetic switches 11, 12, 33-36 is fully functional, fuse-protected or closed. The kitchen appliance 1 has an appliance housing cover 29, which can be used to open the appliance housing 2. The housing appliance cover 29 is also monitored with the aid of a magnetic switch 36 and a sixth magnetic sensor 26. The first tool coupling 15 is suitable for this purpose and is intended to hold a blender receptacle 7 securely. A tool type sensor 40 on the kitchen appliance 1 detects the type of tool 17 inserted and an appliance controller 28 activates the electric motor 3 accordingly, with the speed of the tool 17 in particular being selected appropriately. A fifth magnetic sensor 25 as part of a further magnetic switch 35 monitors the interface 30, which is suitable for holding a grinder (not shown). The use of a plurality of magnetic switches 11, 12, 33-36 and the magnetic sensors 21-26 makes it possible to detect an operating state of the kitchen appliance 1 essentially completely for the purposes of safety and functionality. The magnetic sensors 21-26 are provided as Reed sensors.

FIG. 2 shows a longitudinal section of a blender receptacle 7 of the inventive kitchen appliance 1 with a receptacle handle 8. A rod 9 that can be moved to and fro in the receptacle handle 8 between a first and second position and is configured as a coupling bar 10 is used to monitor the interface 30 at a receptacle cover 6, in that when the receptacle cover 6 is properly inserted, the rod 9 presses onto a second switch slider 14, which is pushed as a result into an intermediate space 38 between a second magnetic sensor 22 and a second magnet 32 arranged on the blender receptacle 7. The second switch slider 14 is made of a ferromagnetic material and directs the magnetic field generated by the second magnet 32 onto the second magnetic sensor 22, which then supplies a corresponding signal to the appliance controller 28. The switch slider 14 can be a cuboidal block made of iron. A first magnetic switch 11 is also arranged on the first tool coupling 15 and is used to monitor the proper insertion of the blender receptacle 7 into the first tool coupling 15, in that a first switch slider is pushed into an intermediate space 38 between a first magnetic sensor 21 and a first magnet 31 so that the magnetic field generated by the first magnet 31 is directed onto the first magnetic sensor, so that this indicates a proper connection between the blender receptacle 7 and the first tool coupling 15. The first magnetic switch 11 has a recess 41, in which the first switch slider 13 has to engage, in order to actuate the first magnetic switch 11. The receptacle cover 6 engages mechanically with the rod 9 at a cover-side end 20 of the rod 9. The rod 9 moves along in a movement direction 42 to and fro between a first and second position, thereby positioning a second switch slider 14 of a second magnetic switch 12 in an intermediate space 38 between a second magnet 32 and a second magnetic sensor 22. The second magnetic switch 12 is arranged on the interface 30.

FIG. 3 shows a longitudinal section of a blender receptacle 7 without a receptacle cover 6. It can be seen that the second switch slider is not arranged in the intermediate space 38, so the second magnetic switch 12 is not closed with the second magnetic sensor 22 and the second magnet 32. The kitchen appliance 1 cannot therefore be operated. A fourth magnetic switch 34 has a magnet 32, which actuates the first magnetic sensor 21 when a blender receptacle 7 is properly inserted in the tool coupling 15. A further magnetic switch 33 is provided on the first tool coupling 15. The further magnetic sensor comprises a recess 41, in which a third magnetic sensor 23 is arranged and in which the assigned second magnet 32 engages. The recess protects the third magnetic sensor 23 from the influence of external magnets (not shown), as it ensures that these are at a sufficient distance from the third magnetic sensor 23. This further enhances the safety of the monitoring process and the functional reliability of the safety regulator 5.

Various further aspects associated with the invention are described below. The individual aspects can each be used individually, in other words independently of each other, or can be combined in any manner.

A particularly advantageous kitchen appliance 1, in particular an electromotive kitchen appliance 1, preferably an electromotive single-purpose or universal food processor, comprises a circuit closer 4 and a safety lock system 5 assigned to the circuit closer 4, which unlocks the circuit closer 4 and permits operation of the kitchen appliance 1 only if the kitchen appliance 1 is properly assembled, the safety lock system 5 having at least one magnetic switch 11, 12, 33-36 with at least one magnet 31, 32 and at least one magnetic sensor 21-26 and is characterized in that the magnetic sensor 21-26 comprises a Reed sensor. A further particularly advantageous kitchen appliance 1, in particular an electromotive kitchen appliance 1, preferably an electromotive single-purpose or universal food processor, comprises a circuit closer 4 and a safety lock system 5 assigned to the circuit closer 4, which unlocks the circuit closer 4 and permits operation of the kitchen appliance 1 only if the kitchen appliance 1 is properly assembled, the safety lock system 5 having at least one magnetic switch 11, 12, 33-36 with at least one magnet 31, 32 and at least one magnetic sensor 21-26, characterized in that the magnetic switch 11, 12, 33-36 has a soft magnetizable, in particular ferromagnetic, switch slider 13, 14, with which it is possible to influence a magnetic field to be detected by the magnetic sensor 21-26, in particular to concentrate it at the magnetic sensor 21-26 or to screen it from the magnetic sensor 21-26. In one development the switch slider 13, 14 can be moved to and fro between a first slider position and a second slider position, in such a manner that, when the kitchen appliance 1 is properly assembled, the switch slider 13, 14 is arranged in an intermediate space 38 between the magnet 31, 32 and the magnetic sensor 21-26 and otherwise outside the intermediate space 38. The volume of the intermediate space 38 is advantageously less than 3 cm³, in particular less than 2 cm³, preferably less than 1 cm³ and/or more than 0.1 cm³, in particular more than 0.3 cm³. In a further refinement the kitchen appliance 1 has at least one attachable tool 7, 17, 18, 39, in particular a pureeing, mixing, chopping, kneading and/or cutting tool, whisk or beater, drinks blender, slicer, grinder, citrus or fruit press, meat mincer and/or a blender receptacle 7, which can be connected to the kitchen appliance 1 with at least one tool coupling 15, 16, 27, with a first magnetic switch 11 with a first magnetic sensor 21 for monitoring the proper connection of the tool 17, 18 to the kitchen appliance 1 being provided on the tool coupling 15, 16, 27. In one development the first magnetic switch 11 has a first magnet 31 and a magnetizable, in particular soft magnetizable, preferably ferromagnetic, first switch slider 13, which can influence a first magnetic field to be detected by the first magnetic sensor 21, with the first magnet 31 being attached on the kitchen appliance side and the first switch slider 13 on the tool side of the tool coupling 15, 16, 27. In a further development the first magnetic switch 11 has a first magnet 31, which is attached on the tool side of the tool coupling 15, 16, 27. The tool 17 is advantageously a blender receptacle 7, having a receptacle cover 6, and a second magnetic switch 12 with a second magnetic sensor 22 is provided to monitor the proper closing of the blender receptacle 7 with the receptacle cover 6. In one refinement a rod 9, which can be moved to and fro between a first position and a second position, in particular a coupling bar 10, is provided on the blender receptacle 7, in particular in a receptacle handle 8 provided on the blender receptacle 7, said rod 9 engaging with the receptacle cover 6 in such a manner that, when the receptacle cover 6 is properly closed, the rod 9 assumes the first position and otherwise the second position, the second magnetic switch 12 being actuatable with the aid of the rod 9. In particular the second magnetic switch 12 has a second magnet 32 and a magnetizable, in particular soft magnetizable, preferably ferromagnetic, second switch slider 14, which can influence a second magnetic field to be detected by the second magnetic sensor 22, in particular concentrating it at the second magnetic sensor 22 or screening it from the second magnetic sensor 22, the second switch slider 14 being provided in particular on the blender receptacle 7. In one development the second switch slider 14 is arranged on the end 19 of the rod 9 facing the tool coupling 15. In particular the second magnet 32 is provided on the blender receptacle 7. In a further refinement the second magnetic sensor 22 is arranged on the end 19 of the rod 9 facing the tool coupling 15. In one embodiment the second magnetic sensor 22 is arranged on the cover-side end 20 of the rod 9. In a further embodiment at least one switch slider 13, 14 is used to carry out a plurality of safety checks with a small number of magnetic switches 11, 12, 33-36, in particular a switch slider 13, 14 is used to carry out at least two safety checks with just one magnetic switch 11, 12, 33-36. In a preferred embodiment a recess 41 is provided to reduce interference due to external magnets, in which recess 41 the magnetic sensor 21-26 is arranged and in which the magnet 31, 32 assigned to the magnetic sensor 21-26 can engage.

The invention relates to a kitchen appliance 1, in particular an electromotive kitchen appliance 1, preferably an electromotive single-purpose or universal food processor, comprising a circuit closer 4 and a safety lock system 5 assigned to the circuit closer 4, which unlocks the circuit closer 4 and permits operation of the kitchen appliance 1 only if the kitchen appliance is properly assembled and provides for the safety lock system 5 to have at least four, preferably at least six, separate magnetic switches 11, 12, 33-36, with magnetic sensors 21-26, in particular Reed sensors or Hall sensors; also a method for operating the kitchen appliance 1. The invention is characterized in that a high level of safety is achieved when the kitchen appliance 1 is used due to the comprehensive monitoring of the kitchen appliance, in particular its tool couplings 15, 16, 27.

### LIST OF REFERENCE CHARACTERS

1 Kitchen appliance
2 Appliance housing
3 Electric motor
4 Circuit closer
5 Safety lock system
6 Receptacle cover
7 Blender receptacle
8 Receptacle handle
9 Rod
10 Coupling bar
11 First magnetic switch
12 Second magnetic switch
13 First switch slider
14 Second switch slider
15 First tool coupling
16 Second tool coupling
17 First tool
18 Second tool
19 Coupling-side end of rod 9
20 Cover-side end of rod 9
21 First magnetic sensor
22 Second magnetic sensor
23 Third magnetic sensor
24 Fourth magnetic sensor
25 Fifth magnetic sensor
   26 Sixth magnetic sensor
   27 Third tool coupling
   28 Appliance controller.
29 Appliance housing cover
30 Interface
31 First magnet
32 Second magnet
33-36 Further magnetic switches
37 Sensor
38 Intermediate space
39 Beater
40 Tool type sensor
41 Recess
42 Movement direction of rod 9

1-14. (canceled)

15. A kitchen appliance comprising:
a circuit closer; and
a safety lock system with a plurality of switches each with a corresponding sensor that unlock the circuit closer and permit operation of the kitchen appliance only if the kitchen appliance is properly assembled.

16. The kitchen appliance of claim 15, wherein one of the sensors includes a Reed sensor.

17. The kitchen appliance of claim 15 further including;
a frame;
a blender receptacle; and
a first tool coupling for connecting the blender receptacle to the frame, wherein a first of the sensors determines a connection between the blender receptacle and the frame by the first tool coupling.

18. The kitchen appliance of claim 17, wherein the blender receptacle has a receptacle cover and a second of the sensors monitors a closing of the blender receptacle with the receptacle cover.

19. The kitchen appliance of claim 18, further including a rod in a receptacle handle of the blender movable between a first position when the receptacle cover closes the blender receptacle and a second position, wherein the rod actuates the second of the sensors.

20. The kitchen appliance of claim 15, further including:
a frame;
a first tool that includes one of a pureer, a mixer, a chopper, a kneader, a cutting tool, a whisker, a beater, a drink blender, a slicer, a grinder, a presser, and a meat mincer; and
a tool coupling that connects the first tool to the frame, wherein one of the sensors monitors a connection between the first tool and the frame.

21. The kitchen appliance of claim 15, further including:
three tool couplings; and
a tool for each of the three tool couplings, wherein one of the tools include one of a pureer, a mixer, a chopper, a kneader, a cutting tool, a whisker, a beater, a drink blender, a slicer, a grinder, a presser, and a meat mincer, wherein one of the sensors is assigned to each of the three tool couplings.

22. The kitchen appliance of claim 21, wherein one of the sensors identifies a type of tool.

23. The kitchen appliance of claim 22, further including a controller that controls a mode of operation.

24. The kitchen appliance of claim 24, wherein the mode of operation includes one of a speed level and a power stage of a motor.

25. The kitchen appliance of claim 15, further including:
a housing; and
a cover that closes the housing, wherein one of the sensors monitors a closing of the housing with the cover.

26. The kitchen appliance of claim 15, wherein one of the plurality of switches actuates in response to a sensor determining that an interface is one of fully functional and fuse-protected.

27. The kitchen appliance of claim 15, wherein one of the switches includes a recess that receives a sensor.

28. The kitchen appliance of claim 15, wherein one of the plurality of switches includes a magnet switch.

29. The kitchen appliance of claim 15, wherein one of the sensors includes a magnetic sensor.

30. A method for operating a kitchen appliance, comprising:
identifying a type of tool using a first sensor;
identifying a mode of operation of the kitchen appliance using a second sensor; and
adjusting one of a speed level and a power stage of a motor based upon one of the identifications.

31. The method of claim 30, wherein a type of tool includes one of a pureer, a mixer, a chopper, a kneader, a cutting tool, a whisker, a beater, a drink blender, a slicer, a grinder, a presser, and a meat mincer.

32. The method of claim 30, wherein one of the sensors includes a magnetic sensor.
